(19) United States
(12) Patent Application Publication
(10) Pub. No.: US 2019/0156974 A1
(43) Pub. Date: May 23, 2019

(54) ND-FE-B MAGNET INCLUDING A COMPOSITE COATING DISPOSED THEREON AND A METHOD OF DEPOSITING A COMPOSITE COATING ON THE ND-FE-B MAGNET

(71) Applicant: Yantai Shougang Magnetic Materials, Inc., Yantai (CN)

(72) Inventors: Changbo Xie, Yantai (CN); Dejin Chen, Yantai (CN)

(21) Appl. No.: 16/194,193

(22) Filed: Nov. 16, 2018

(30) Foreign Application Priority Data
Nov. 17, 2017 (CN) 201711141628.3

(51) Int. Cl. H01F 1/057; H01F 41/02

(52) U.S. Cl. CPC H01F 1/0572; H01F 41/026

(57) ABSTRACT

An Nd—Fe—B magnet includes a magnet body and a composite coating of metal disposed on the body. The compositing coating has a plurality of plating layers disposed on the magnet body to cover and protect the magnet body and improve corrosion resistance of the magnet body. The plating layers include a first, a second, a third, and a fourth plating layers to cover the magnet body. The first plating layer contains Zn. The second plating layer contains a Zinc-Nickel alloy. The third plating layer contains Copper. The fourth plating layer contains Nickel. A method of depositing on a composite layer on an Nd—Fe—B magnet body.

### CROSS REFERENCE TO RELATED APPLICATION

This application claims priority to Chinese application serial number CN201711141628.3 filed on Nov. 17, 2017, the entire disclosure of which is incorporated herein by reference in its entirety.

### BACKGROUND OF THE INVENTION

### 1. Field of the Invention

The present invention generally relates to an Nd—Fe—B magnet including a composite coating and a method of depositing a composite coating on the Nd—Fe—B magnet.

### 2. Description of the Prior Art

New types of Nd—Fe—B magnets are made from a third generation rare-earth material. The third generation rare-earth material, typically includes a Nd₂Fe₁₄B main crystal phase and a neodymium rich grain boundary phase, has a poor corrosion resistance. In addition, temperature easily affects the third generation rare-earth material's magnetic structure. Accordingly, a composite plating process is used to dispose a composite coating on the surface of the Nd—Fe—B magnets to provide improved corrosion resistance and prevent thermal demagnetization of the Nd—Fe—B magnets.

Currently, the composite coating disposed on the surface of the Nd—Fe—B magnets include Zn plating layer, Ni—Ni plating layer, Ni—Cu—Ni plating layer, Al plating layer, and epoxy plating layer. Each of the layers has its own advantages and disadvantages. For example, the Ni—Ni plating layer and the Ni—Cu—Ni plating layer has greater influences on the thermal demagnetization of the Nd—Fe—B magnets, especially in small size products such as mobile components. On the other hand, the wear resistances of Zn plating layer, Al plating layer and epoxy plating layer are very poor. When the products require both wear resistance and the low thermal demagnetization, it is difficult to satisfy this requirement with the present composite coating.

### SUMMARY OF THE INVENTION

The present invention overcomes the deficiencies mentioned above and provides an Nd—Fe—B magnet having a composite coating that is unaffected by thermal demagnetization. The present invention also provides a composite coating having improved bonding/adhesion between the composite coating and the Nd—Fe—B magnet. The present invention further provides an Nd—Fe—B magnet having a composite coating wherein the composite coating of having improved corrosion resistance.

It is one aspect of the present invention to provide an Nd—Fe—B magnet. The Nd—Fe—B magnet includes a magnet body and a composite coating. The composite coating includes a plurality of plating layers with each one of the plating layers being made from metal and disposed on the magnet body to cover and protect the magnet body and improve corrosion resistance of the magnet body.

It is another aspect of the present invention to provide a method of depositing a composite layer on an Nd—Fe—B magnet body. The method includes a first step of providing the Nd—Fe—B magnet body including grease and dust and rust and an oxide layer disposed on the Nd—Fe—B magnet body. The next step of the method includes cleaning the Nd—Fe—B magnet body to remove the grease, the dust, the rust, and the oxide layer from the Nd—Fe—B magnet body and produce a cleaned Nd—Fe—B magnet. Then, the cleaned Nd—Fe—B magnet is activated to produce an activated Nd—Fe—B magnet. Next, a composite layer is deposited on the activated Nd—Fe—B magnet. The Nd—Fe—B magnet including the composite layer is then dried. The step of depositing the composite layer includes a step of depositing a first plating layer containing Zinc having a first thickness of between 0.1 μm and 10 μm on the activated Nd—Fe—B after said step of cleaning to produce an Nd—Fe—B magnet including the first plating layer. The step of depositing the composite layer also includes a step of depositing a second plating layer containing Zinc-Nickel alloy having a second thickness of between 0.1 μm and 10 μm and having a Nickel content of between 5% to 25% on the Nd—Fe—B magnet including the first plating layer to produce an Nd—Fe—B magnet including the second plating layer. The step of depositing the composite layer further includes a step of depositing a third plating layer containing Copper having a third thickness of between 0.1 μm and 10 μm on the Nd—Fe—B magnet including the second plating layer to produce an Nd—Fe—B magnet including the third plating layer. The step of depositing the composite layer includes a step of depositing a fourth plating layer containing Nickel having a fourth thickness of between 0.1 μm and 10 μm on the Nd—Fe—B magnet including the third plating layer to produce an Nd—Fe—B magnet including the composite layer.

### DESCRIPTION OF THE ENABLING EMBODIMENT

It is one aspect of the present invention to provide an Nd—Fe—B magnet. The Nd—Fe—B magnet includes a magnet body and a composite coating. The composite coating includes a plurality of plating layers with each one of the plating layers being made from metal and disposed on the magnet body to cover and protect the magnet body and improve corrosion resistance of the magnet body. The composite coating includes a first, second, third, and fourth plating layers.

The first plating layer of the composite coating contains Zinc disposed on the magnet body. It should be appreciated that, in another embodiment of the present invention, the first plating layer can consist only of Zinc. The first plating layer has a first thickness of between 0.1 μm and 10 μm to cover said magnet body. The second plating layer of the composite coating contains Zinc-Nickel alloy disposed on the first plating layer. In other words, the second plating layer is disposed directly over the first plating layer. In one embodiment of the present invention, the second plating layer contains Zinc-Nickel alloy wherein the Zinc-Nickle Alloy has a Nickel content of between 5% to 25%. It should be appreciated that, in another embodiment of the present invention, the second plating layer can consist only of Zinc-Nickel alloy. The second thickness of between 0.1 μm and 10 μm to cover the first plating layer. The third plating layer of the composite coating, disposed on the second plating layer, contains Copper and has a third thickness of between 0.1 μm and 10 μm to cover the second plating layer. It should be appreciated that, in another embodiment of the present invention, the third plating layer can consist only of Copper. The fourth plating layer of the composite coating, disposed on the third plating layer, contains Nickel and has a fourth thickness of between 0.1 μm and 10 μm to cover the third plating layer. It should be appreciated that, in another embodiment of the present invention, the fourth plating layer can consist only of Nickel.

It is another aspect of the present invention to provide a method of depositing a composite layer on an Nd—Fe—B magnet body. The method includes a first step of providing the Nd—Fe—B magnet body including grease, dust, rust, and an oxide layer disposed on the Nd—Fe—B magnet body. The next step of the method is shaping the Nd—Fe—B magnet body. It should be appreciated that the step of shaping can be performed by grinding and chamfering the Nd—Fe—B magnet in a centrifugal or vibratory polishing machine for 1 to 10 hours.

After shaping the Nd—Fe—B magnet body, the Nd—Fe—B magnet body is cleaned to produce a cleaned Nd—Fe—B magnet. The step of cleaning can include steps of removing the grease, removing the rust and the oxide layer, and removing the dust from the Nd—Fe—B magnet body. The step removing the grease can be performed by hot-dipping the Nd—Fe—B magnet body in a universal degreasing powder solution to remove the grease from the Nd—Fe—B magnet body. Following the step of hot-dipping and the step of removing the grease, the Nd—Fe—B magnet body can be rinsed using water. The step of removing the rust and the oxide layer from the Nd—Fe—B magnet body can be performed by washing the Nd—Fe—B magnet using an acid solution containing nitric acid of between 1 wt. % to 10 wt. %. After removing the rust and the oxide layer, the dust is removed from the Nd—Fe—B magnet body by subjecting the Nd—Fe—B magnet to an ultrasonic cleaning process.

After cleaning the Nd—Fe—B magnet body, the surface of the cleaned Nd—Fe—B magnet is activated to produce an activated Nd—Fe—B magnet. The step of activating the cleaned Nd—Fe—B magnet can be performed by corroding the Nd—Fe—B magnet with an acidic solution. The acidic solution has a concentration of between 0.1 wt. % and 2 wt. %. After activating the surface of the Nd—Fe—B magnet, the activated Nd—Fe—B magnet is cleaned by washing the Nd—Fe—B magnet using tap water and pure water. After producing the activated Nd—Fe—B magnet, the next step of the method includes depositing a composite layer on the Nd—Fe—B magnet. The step of depositing the composite layer includes step of depositing a first, second, third, and fourth plating layer on the activated Nd—Fe—B magnet.

The step of depositing the first plating layer includes a step of depositing a first plating layer containing Zinc having a first thickness of between 0.1 μm and 10 μm on the activated Nd—Fe—B magnet to produce an Nd—Fe—B magnet including the first plating layer. It should be appreciated that, in another embodiment of the present invention, the first plating layer can consist only of Zinc. The step of depositing the first plating layer containing Zinc can be performed by electroplating the first plating layer containing Zinc onto the activated Nd—Fe—B magnet. The step of electroplating the first plating layer can be conducted by rack or barrel plating using a first plating solution having a pH of between 3.0 and 6.0. The first plating solution contains ZnCl present between 20 g/L and 120 g/L, KCl present between 120 g/L and 320 g/L, H₃BO₃ present between 10 g/L and 100 g/L, and HT-MB zinc acid additive and zinc acid brightener present between 0.1 g/L and 50 g/L. It should be appreciated that the step of depositing the first plating layer can further include a step of polishing the Nd—Fe—B magnet including the first plating layer by using a polishing solution containing nitric acid being present between 0.1 vol. % and 3 vol. % to produce a polished Nd—Fe-b magnet. After polishing, the polished Nd—Fe—B magnet is rinsed using water or pure water.

The step of depositing the second plating layer is further defined as depositing a second plating layer containing Zinc-Nickel alloy having a second thickness of between 0.1 μm and 10 μm on the Nd—Fe—B magnet including the first plating layer to produce an Nd—Fe—B magnet including the second plating layer. In other words, the second plating layer is disposed over the first plating layer to cover the first plating layer. The Zinc-Nickel ally also has a Nickel content of between 5% to 25%. It should be appreciated that, in another embodiment of the present invention, the second plating layer can consist only of Zinc-Nickel alloy. The step of depositing the second plating layer can be conducted by electroplating the second plating layer of Zinc-Nickel alloy onto the Nd—Fe—B magnet including the first plated layer by rack or barrel plating using a second plating solution. The second plating solution contains Zn²⁺ ions present between 2 g/L and 20 g/L, Ni²⁺ ions present between 1 g/L and 10 g/L, a metal complexing agent present between 50 g/L and 200 g/L, and NaOH present between 20 g/L and 200 g/L. The step of depositing the second plating layer further includes a step of washing the Nd—Fe—B magnet including the second plating layer using water to produce a washed Nd—Fe—B magnet.

The step of depositing the third plating layer is further defined as depositing the third plating layer containing Copper having a third thickness of between 0.1 μm and 10 μm on the Nd—Fe—B magnet including the second plating layer to produce an Nd—Fe—B magnet including the third plating layer. In other words, the third plating layer is disposed over the second plating layer to cover the second plating layer. It should be appreciated that, in another embodiment of the present invention, the third plating layer can consist only of Copper. The step of depositing the third plating layer can be conducted by electroplating the third plating layer containing Copper onto the washed Nd—Fe—B magnet by rack or barrel plating using a third plating solution. The third plating solution has a pH of between 7 and 10 and contains Copper Pyrophosphate present between 20 g/L and 120 g/L, Potassium Pyrophosphate present between 100 g/L and 300 g/L, and a Copper Pyrophosphate agent and a Copper Pyrophosphate brightener present between 0.1 g/L and 50 g/L. The step of depositing the third plating layer further includes a step of activating the Nd—Fe—B magnet including the third plating layer. The step of activating the Nd—Fe—B magnet can be conducted by corroding the Nd—Fe—B magnet including the third plating layer using a solution containing hydrochloric acid having a concentration of between 1 vol. % and 5 vol. %. After activating, the Nd—Fe—B magnet including the third plating layer is washed using water.

The step of depositing the fourth plating layer is further defined as depositing the fourth plating layer containing Nickel having a fourth thickness of between 0.1 μm and 10 μm on the Nd—Fe—B magnet including the third plating layer to produce an Nd—Fe—B magnet including the composite layer. In other words, the fourth plating layer is disposed over the third plating layer to cover the third plating layer. It should be appreciated that, in another embodiment of the present invention, the fourth plating layer can consist only of Nickel. The step of depositing the fourth plating layer can be conducted by electroplating the fourth plating layer containing Nickel onto the Nd—Fe—B magnet including the third plating layer by rack or barrel plating using a fourth plating solution. The fourth plating solution has a pH of between 3 and 5 and contains NiSO₄ present between 150 g/L and 350 g/L, NiCl₂ present between 10 g/L and 100 g/L, H₃BO₃ present between 10 g/L and 100 g/L, and an Ni-88 Brightener and an A-5 softener being present between 0.1 g/L and 50 g/L. The first, second, third, and fourth plating layers, together, defines the composite coating on the Nd—Fe—B magnet.

When electroplating the first, second, third, and fourth plating layers on to the Nd—Fe—B magnet, it should be appreciated that the Nd—Fe—B magnet, i.e. the activated Nd—Fe—B magnet and the Nd—Fe—B magnet including the first, second, or third plating layers, is a cathode immersed in the first, second, third, or fourth plating solutions. The metals plating on the Nd—Fe—B magnet is the anode.

After depositing the composite coating, the method includes a step of drying the Nd—Fe—B magnet. To dry the Nd—Fe—B magnet including the composite coating, the Nd—Fe—B magnet is first washed using tap water and pure water. After washing, the Nd—Fe—B magnet including the composite layer is desiccated.

It should be appreciated that, the steps of shaping the Nd—Fe—B magnet, cleaning the Nd—Fe—B magnet and the activating of the cleaned Nd—Fe—B magnet steps allows a strong first plating layer containing Zinc to form on the surface of the Nd—Fe—B magnet whereby the first plating layer containing Zinc is resistant to the thermal demagnetization. After forming the first plating layer on the Nd—Fe—B magnet, transition layers, e.g. the second plating layer containing Zinc-Nickel alloy and the third plating layer containing Copper, are disposed over the first plating layer. This ensures that the adhesion between the plating layers is strong and improve the corrosion resistance of the composite coating. Finally, the fourth plating layer containing Nickel is disposed over the third plating layer to improve the adhesive and the stability of the plating layers. In addition, the fourth plating layer containing Nickel also provides wear and corrosion resistance to the Nd—Fe—B magnet.

Implementing examples below provide a better illustration of the present invention. The implementing examples are used for illustrative purposes only and do not limit the scope of the present invention.

### IMPLEMENTING EXAMPLE 1

In Implementing Example 1, barrel plating is used for plating the Nd—Fe—B magnet. The Nd—Fe—B magnet body including grease, dust, rust, and an oxide layer is shaped by grinding and chamfering the Nd—Fe—B magnet in a centrifugal polishing machine to a size having a radius between 0.2 mm and 0.3 mm for 3 hours. After shaping the Nd—Fe—B magnet body, the Nd—Fe—B magnet body is cleaned to produce a cleaned Nd—Fe—B magnet. First, the grease is removed from the Nd—Fe—B magnet body by hot-dipping the Nd—Fe—B magnet body in a universal degreasing powder solution having a volumetric concentration of 40 g/L to remove the grease from the Nd—Fe—B magnet body. Following the step of hot-dipping and the step of removing the grease, the Nd—Fe—B magnet body is rinsed using water for 1-2 minutes. Then, the rust and the oxide layer are removed from the Nd—Fe—B magnet body by washing the Nd—Fe—B magnet using an acid solution containing nitric acid of 3 wt. % for 60 seconds. After removing the rust and the oxide layer, the dust is removed from the Nd—Fe—B magnet body by subjecting the Nd—Fe—B magnet to an ultrasonic cleaning process for 3 minutes.

After cleaning the Nd—Fe—B magnet body, the surface of the cleaned Nd—Fe—B magnet is activated by corroding the Nd—Fe—B magnet with an acidic solution to produce an activated Nd—Fe—B magnet. The acidic solution contains nitric acid present in 1 wt. % for 15 seconds. After activating the surface of the Nd—Fe—B magnet, the activated Nd—Fe—B magnet is cleaned by washing the Nd—Fe—B magnet using tap water for 60 seconds and, then, using pure water for 60 seconds. After producing the activated Nd—Fe—B magnet, the activated Nd—Fe—B magnet is disposed in a hexagonal shaped barrel for depositing a composite layer on the activated Nd—Fe—B magnet to produce an Nd—Fe—B magnet including the composite layer. The step of depositing the composite layer includes step of depositing a first, second, third, and fourth plating layers on the activated Nd—Fe—B magnet.

The first plating layer contains Zinc and is disposed on the activated Nd—Fe—B magnet by electroplating the first plating layer of Zinc onto the activated Nd—Fe—B magnet to produce an Nd—Fe—B magnet including the first plating layer. The first plating solution has a pH between 3.0 and 6.0 and also contains ZnCl present between 20 g/L and 120 g/L, KCl present between 120 g/L and 320 g/L, H₃BO₃ present between 10 g/L and 100 g/L, and HT-MB zinc acid additive and zinc acid brightener present between 0.1 g/L and 50 g/L. It should be appreciated that, based on the sizes of the Nd—Fe—B magnet body, different sizes of the barrel can be used for controlling the thickness of the plating layers. During the electroplating process, the thickness of the first plating layer is controlled to be between 0.1 μm and 10 μm. After electroplating, the Nd—Fe—B magnet including the first plating layer is polished by using a polishing solution containing nitric acid present at 1 vol. % to produce a polished Nd—Fe-b magnet. After polishing, the polished Nd—Fe—B magnet is rinsed using water and pure water for 60 seconds.

Then, the Nd—Fe—B magnet including the first plating layer is placed in a tank containing Zinc-Nickel alloy for electroplating the second plating layer on the Nd—Fe—B magnet including the first plating layer to produce an Nd—Fe—B magnet including the second plating layer. The second plating layer contains Zinc-Nickel alloy. The Zinc-Nickel ally also has a Nickel content of between 5% to 25%. A second plating solution is used when electroplating the second plating layer. The second plating solution contains Zn²⁺ ions present between 2 g/L and 20 g/L, Ni²⁺ ions present between 1 g/L and 10 g/L, a metal complexing agent present between 50 g/L and 200 g/L, and NaOH present between 20 g/L and 200 g/L. During the electroplating process, the thickness of the second plating layer is controlled to be between 0.1 μm and 10 μm. After electroplating, the Nd—Fe—B magnet including the second plating layer is washed using water to produce a washed Nd—Fe—B magnet.

Next, the third plating layer is electroplated on the Nd—Fe—B magnet including the second plating layer to produce an Nd—Fe—B magnet including the third plating layer. The third plating layer contains Copper. A third plating solution is used when electroplating the third plating layer. The third plating solution has a pH of between 7 and 10 and contains Copper Pyrophosphate present between 20 g/L and 120 g/L, Potassium Pyrophosphate present between 100 g/L and 300 g/L, and a Copper Pyrophosphate agent and a Copper Pyrophosphate brightener present between 0.1 g/L and 50 g/L. To avoid displacement during the plating, the Nd—Fe—B magnets having the second plating layer can charged before placing it in the third plating solution. During the electroplating process, the thickness of the third plating layer is controlled to be between 0.1 μm and 10 μm. After electroplating, the surface of the Nd—Fe—B magnet including the third plating layer is activated by corroding the Nd—Fe—B magnet including the third plating layer using a solution containing hydrochloric acid having a concentration of 3 vol. % for 35 seconds. After activating, the Nd—Fe—B magnet including the third plating layer is washed using water.

Then, the fourth plating layer is disposed on the Nd—Fe—B magnet including the third plating layer to produce an Nd—Fe—B magnet including the composite coating. The fourth plating layer contains Nickel. A fourth electroplating solution is used when electroplating the fourth plating layer. The fourth plating solution has a pH of between 3 and 5 and contains NiSO₄ present between 150 g/L and 350 g/L, NiCl₂ present between 10 g/L and 100 g/L, H₃BO₃ present between 10 g/L and 100 g/L, and an Ni-88 Brightener and an A-5 softener being present between 0.1 g/L and 50 g/L. During the electroplating process, the thickness of the second plating layer is controlled to be between 0.1 μm and 10 μm. After electroplating, the Nd—Fe—B magnet including the composite coating is washed and dried using a blow dryer or a centrifugal dryer. The first, second, third, and fourth plating layers, together, defines the composite coating on the Nd—Fe—B magnet. The order of the plating layers are Zn, Zn+Ni Alloy, Copper, and Nickel.

The Nd—Fe—B magnet including the composite coating produced in accordance with Implementing Example 1 has a size of 9.14 mm×6.39 mm×0.85 mm and has a label of 48H. The Nd—Fe—B exhibits no change in size after 96 hours of salt spraying test. In addition, the thermal demagnetization of the Nd—Fe—B magnet including the composite coating is less than 2% at 120° C. The thrust bearing for the composite coating on the Nd—Fe—B magnet is greater than 300N. In comparison, the surface of an Nd—Fe—B magnet including a Ni—Cu—Ni coating begins to rust after 72 hours of the salt spraying test. At 120° C. the thermal demagnetization of the Nd—Fe—B magnet including the Ni—Cu—Ni coating is 8%. The thrust bearing for the Ni—Cu—Ni coating on the Nd—Fe—B magnet is 220N.

### IMPLEMENTING EXAMPLE 2

In Implementing Example 2, rack plating is used for plating the Nd—Fe—B magnet. The Nd—Fe—B magnet body including grease, dust, rust, and an oxide layer is shaped by grinding and chamfering the Nd—Fe—B magnet in a centrifugal polishing machine to a size having a radius between 0.4 mm and 0.5 mm for 10 hours. After shaping the Nd—Fe—B magnet body, the Nd—Fe—B magnet body is cleaned to produce a cleaned Nd—Fe—B magnet. First, the grease is removed from the Nd—Fe—B magnet body by hot-dipping the Nd—Fe—B magnet body in a universal degreasing powder solution having a volumetric concentration of 40 g/L to remove the grease from the Nd—Fe—B magnet body. Following the step of hot-dipping and the step of removing the grease, the Nd—Fe—B magnet body is rinsed using water for 1-2 minutes. Then, the rust and the oxide layer are removed from the Nd—Fe—B magnet body by washing the Nd—Fe—B magnet using an acid solution containing nitric acid between 1 wt. % and 10 wt. % for 90 seconds. After removing the rust and the oxide layer, the dust is removed from the Nd—Fe—B magnet body by subjecting the Nd—Fe—B magnet to an ultrasonic cleaning process for 5 minutes.

After cleaning the Nd—Fe—B magnet body, the surface of the cleaned Nd—Fe—B magnet is activated by corroding the Nd—Fe—B magnet with an acidic solution to produce an activated Nd—Fe—B magnet. The acidic solution contains nitric acid present between 0.1 wt. % and 1 wt. % for 30 seconds. After activating the surface of the Nd—Fe—B magnet, the activated Nd—Fe—B magnet is cleaned by washing the Nd—Fe—B magnet using tap water for 60 seconds and, then, using pure water for 60 seconds. After producing the activated Nd—Fe—B magnet, the activated Nd—Fe—B magnet is disposed on a rack for depositing a composite layer on the activated Nd—Fe—B magnet to produce an Nd—Fe—B magnet including the composite layer. The step of depositing the composite layer includes step of depositing a first, second, third, and fourth plating layers on the activated Nd—Fe—B magnet.

The first plating layer contains Zinc is disposed on the activated Nd—Fe—B magnet by electroplating the first plating layer of Zinc onto the activated Nd—Fe—B magnet to produce an Nd—Fe—B magnet including the first plating layer. The first plating solution has a pH between 3.0 and 6.0 and also contains ZnCl present between 20 g/L and 120 g/L, KCl present between 120 g/L and 320 g/L, H₃BO₃ present between 10 g/L and 100 g/L, and HT-MB zinc acid additive and zinc acid brightener present between 0.1 g/L and 50 g/L. During the electroplating process, the thickness of the first plating layer is controlled to be between 0.1 μm and 10 μm. After electroplating, the Nd—Fe—B magnet including the first plating layer is polished by using a polishing solution containing nitric acid present between 1 vol. % and 3 vol. % to produce a polished Nd—Fe-b magnet. After polishing, the polished Nd—Fe—B magnet is rinsed.

Then, the second plating layer is electroplated on the Nd—Fe—B to produce an Nd—Fe—B magnet including the second plating layer. The second plating layer contains Zinc-Nickel alloy. The Zinc-Nickel ally also has a Nickel content of between 5% to 25%. A second plating solution is used when electroplating the second plating layer. The second plating solution contains Zn²⁺ ions present between 2 g/L and 20 g/L, Ni²⁺ ions present between 1 g/L and 10 g/L, a metal complexing agent present between 50 g/L and 200 g/L, and NaOH present between 20 g/L and 200 g/L. During the electroplating process, the thickness of the second plating layer is controlled to be between 0.1 μm and 10 μm. After electroplating, the Nd—Fe—B magnet including the second plating layer is washed using water to produce a washed Nd—Fe—B magnet.

Next, the third plating layer is electroplated on the Nd—Fe—B magnet including the second plating layer to produce an Nd—Fe—B magnet including the third plating layer. The third plating layer contains Copper. A third plating solution is used when electroplating the third plating layer. The third plating solution has a pH of between 7 and 10 and contains Copper Pyrophosphate present between 20 g/L and 120 g/L, Potassium Pyrophosphate present between 100 g/L and 300 g/L, and a Copper Pyrophosphate agent and a Copper Pyrophosphate brightener present between 0.1 g/L and 50 g/L. During the electroplating process, the thickness of the third plating layer is controlled to be between 0.1 μm and 10 μm. After electroplating, the surface of the Nd—Fe—B magnet including the third plating layer is activated by corroding the Nd—Fe—B magnet including the third plating layer using a solution containing hydrochloric acid having a concentration between 1 vol. % and 5 vol. % for 60 seconds. After activating, the Nd—Fe—B magnet including the third plating layer is washed using water.

Then, the fourth plating layer is disposed on the Nd—Fe—B magnet including the third plating layer to produce an Nd—Fe—B magnet including the composite coating. The fourth plating layer contains Nickel. A fourth electroplating solution is used when electroplating the fourth plating layer. The fourth plating solution has a pH of between 3 and 5 and contains NiSO₄ present between 150 g/L and 350 g/L, NiCl₂ present between 10 g/L and 100 g/L, H₃BO₃ present between 10 g/L and 100 g/L, and an Ni-88 Brightener and an A-5 softener being present between 0.1 g/L and 50 g/L. During the electroplating process, the thickness of the second plating layer is controlled to be between 0.1 μm and 10 μm. After electroplating, the Nd—Fe—B magnet including the composite coating is washed and dried using a blow dryer or a centrifugal dryer. The first, second, third, and fourth plating layers, together, defines the composite coating on the Nd—Fe—B magnet. The order of the plating layers are Zn, Zn+Ni Alloy, Copper, and Nickel.

### IMPLEMENTING EXAMPLE 3

In Implementing Example 3, barrel plating is used for plating the Nd—Fe—B magnet. The Nd—Fe—B magnet body including grease, dust, rust, and an oxide layer is shaped by grinding and chamfering the Nd—Fe—B magnet in a centrifugal polishing machine to a size having a radius between 0.2 mm and 0.3 mm for 1 hour. After shaping the Nd—Fe—B magnet body, the Nd—Fe—B magnet body is cleaned to produce a cleaned Nd—Fe—B magnet. First, the grease is removed from the Nd—Fe—B magnet body by hot-dipping the Nd—Fe—B magnet body in a universal degreasing powder solution having a volumetric concentration of 40 g/L to remove the grease from the Nd—Fe—B magnet body. Following the step of hot-dipping and the step of removing the grease, the Nd—Fe—B magnet body is rinsed using water for 1-2 minutes. Then, the rust and the oxide layer are removed from the Nd—Fe—B magnet body by washing the Nd—Fe—B magnet using an acid solution containing nitric acid of 3 wt. % for 30 seconds. After removing the rust and the oxide layer, the dust is removed from the Nd—Fe—B magnet body by subjecting the Nd—Fe—B magnet to an ultrasonic cleaning process for 1 minute.

After cleaning the Nd—Fe—B magnet body, the surface of the cleaned Nd—Fe—B magnet is activated by corroding the Nd—Fe—B magnet with an acidic solution to produce an activated Nd—Fe—B magnet. The acidic solution contains nitric acid present between 0.1 wt. % and 1 wt. % for 5 seconds. After activating the surface of the Nd—Fe—B magnet, the activated Nd—Fe—B magnet is cleaned by washing the Nd—Fe—B magnet using tap water for 60 seconds and, then, using pure water for 60 seconds. After producing the activated Nd—Fe—B magnet, the activated Nd—Fe—B magnet is disposed in a hexagonal shaped barrel for depositing a composite layer on the activated Nd—Fe—B magnet to produce an Nd—Fe—B magnet including the composite layer. The step of depositing the composite layer includes step of depositing a first, second, third, and fourth plating layers on the activated Nd—Fe—B magnet.

The first plating layer contains Zinc and is disposed on the activated Nd—Fe—B magnet by electroplating the first plating layer of Zinc onto the activated Nd—Fe—B magnet to produce an Nd—Fe—B magnet including the first plating layer. The first plating solution has a pH between 3.0 and 6.0 and also contains ZnCl present between 20 g/L and 120 g/L, KCl present between 120 g/L and 320 g/L, H₃BO₃ present between 10 g/L and 100 g/L, and HT-MB zinc acid additive and zinc acid brightener present between 0.1 g/L and 50 g/L. It should be appreciated that, based on the sizes of the Nd—Fe—B magnet body, different sizes of the barrel can be used for controlling the thickness of the plating layers. During the electroplating process, the thickness of the first plating layer is controlled to be between 0.1 μm and 10 μm. After electroplating, the Nd—Fe—B magnet including the first plating layer is polished by using a polishing solution containing nitric acid present at 1 vol. % to produce a polished Nd—Fe-b magnet. After polishing, the polished Nd—Fe—B magnet is rinsed using water and pure water for 60 seconds.

Then, the Nd—Fe—B magnet including the first plating layer is placed in a tank containing Zinc-Nickel alloy for electroplating the second plating layer on the Nd—Fe—B magnet including the first plating layer to produce an Nd—Fe—B magnet including the second plating layer. The second plating layer contains Zinc-Nickel alloy. The Zinc-Nickel ally also has a Nickel content of between 5% to 25%. A second plating solution is used when electroplating the second plating layer. The second plating solution contains Zn²⁺ ions present between 2 g/L and 20 g/L, Ni²⁺ ions present between 1 g/L and 10 g/L, a metal complexing agent present between 50 g/L and 200 g/L, and NaOH present between 20 g/L and 200 g/L. During the electroplating process, the thickness of the second plating layer is controlled to be between 0.1 μm and 10 μm. After electroplating, the Nd—Fe—B magnet including the second plating layer is washed using water to produce a washed Nd—Fe—B magnet.

Next, the third plating layer is electroplated on the Nd—Fe—B magnet including the second plating layer to produce an Nd—Fe—B magnet including the third plating layer. The third plating layer contains Copper. A third plating solution is used when electroplating the third plating layer. The third plating solution has a pH of between 7 and 10 and contains Copper Pyrophosphate present between 20 g/L and 120 g/L, Potassium Pyrophosphate present between 100 g/L and 300 g/L, and a Copper Pyrophosphate agent and a Copper Pyrophosphate brightener present between 0.1 g/L and 50 g/L. To avoid displacement during the plating, the Nd—Fe—B magnets having the second plating layer can charged before placing it in the third plating solution. During the electroplating process, the thickness of the third plating layer is controlled to be between 0.1 μm and 10 μm. After electroplating, the surface of the Nd—Fe—B magnet including the third plating layer is activated by corroding the Nd—Fe—B magnet including the third plating layer using a solution containing hydrochloric acid having a concentration between 1 vol. % and 5 vol. % for 10 seconds. After activating, the Nd—Fe—B magnet including the third plating layer is washed using water.

Then, the fourth plating layer is disposed on the Nd—Fe—B magnet including the third plating layer to produce an Nd—Fe—B magnet including the composite coating. The fourth plating layer contains Nickel. A fourth electroplating solution is used when electroplating the fourth plating layer. The fourth plating solution has a pH of between 3 and 5 and contains NiSO₄ present between 150 g/L and 350 g/L, NiCl₂ present between 10 g/L and 100 g/L, H₃BO₃ present between 10 g/L and 100 g/L, and an Ni-88 Brightener and an A-5 softener being present between 0.1 g/L and 50 g/L. During the electroplating process, the thickness of the second plating layer is controlled to be between 0.1 μm and 10 μm. After electroplating, the Nd—Fe—B magnet including the composite coating is washed and dried using a blow dryer or a centrifugal dryer. The first, second, third, and fourth plating layers, together, defines the composite coating on the Nd—Fe—B magnet. The order of the plating layers are Zn, Zn+Ni Alloy, Copper, and Nickel.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. An Nd—Fe—B magnet comprising:
a magnet body; and
a composite coating including a plurality of plating layers with each one of said plating layers being made from metal and disposed on said magnet body to cover and protect said magnet body and improve corrosion resistance of said magnet body.

2. The Nd—Fe—B magnet as set forth in claim 1 wherein said composite coating has a total thickness of between 0.4 μm and 40 μm.

3. The Nd—Fe—B magnet as set forth in claim 1 wherein said plating layers include a first plating layer containing Zinc disposed on said magnet body to cover said magnet body.

4. The Nd—Fe—B magnet as set forth in claim 3 wherein said first plating layer has a first thickness of between 0.1 μm and 10 μm.

5. The Nd—Fe—B magnet as set forth in claim 3 wherein said plating layers include a second plating layer containing a Zinc-Nickel alloy disposed on said first plating layer to cover said first plating layer.

6. The Nd—Fe—B magnet as set forth in claim 5 wherein said second plating layer has a second thickness of between 0.1 μm and 10 μm.

7. The Nd—Fe—B magnet as set forth in claim 5 wherein said second plating layer of has a Nickel content of between 5% to 25%.

8. The Nd—Fe—B magnet as set forth in claim 5 wherein said plating layers include a third plating layer containing Copper disposed on said second plating layer to cover said second plating layer.

9. The Nd—Fe—B magnet as set forth in claim 8 wherein said third plating layer has a third thickness of between 0.1 μm and 10 μm.

10. The Nd—FE-B magnet as set forth in claim 8 wherein said plating layers include a fourth plating layer containing Nickel disposed on said third plating layer to cover said third plating layer.

11. The Nd—Fe—B magnet a set forth in claim 10 wherein said fourth plating layer has a fourth thickness of between 0.1 μm and 10 μm.

12. A method of depositing a composite layer on an Nd—Fe—B magnet body, said method including the steps of:
providing the Nd—Fe—B magnet body including grease and dust and rust and an oxide layer disposed on the Nd—Fe—B magnet body;
cleaning the Nd—Fe—B magnet body to remove the grease, the dust, the rust, and the oxide layer from the Nd—Fe—B magnet body and produce a cleaned Nd—Fe—B magnet;
activating the cleaned Nd—Fe—B magnet to produce an activated Nd—Fe—B magnet;
depositing a composite layer on the activated Nd—Fe—B magnet; and
said step of depositing the composite layer including a step of depositing a first plating layer containing Zinc having a first thickness of between 0.1 μm and 10 μm on the activated Nd—Fe—B after said step of cleaning to produce an Nd—Fe—B magnet including the first plating layer;
said step of depositing the composite layer including a step of depositing a second plating layer containing Zinc-Nickel alloy having a second thickness of between 0.1 μm and 10 μm and having a Nickel content of between 5% to 25% on the Nd—Fe—B magnet including the first plating layer to produce an Nd—Fe—B magnet including the second plating layer;
said step of depositing the composite layer including a step of depositing a third plating layer containing Copper having a third thickness of between 0.1 μm and 10 μm on the Nd—Fe—B magnet including the second plating layer to produce an Nd—Fe—B magnet including the third plating layer;
said step of depositing the composite layer including a step of depositing a fourth plating layer containing Nickel having a fourth thickness of between 0.1 μm and 10 μm on the Nd—Fe—B magnet including the third plating layer to produce an Nd—Fe—B magnet including the composite layer.

13. The method as set forth in claim 11 wherein said step of depositing the first plating layer of Zinc is defined as electroplating the first plating layer containing Zinc onto the activated Nd—Fe—B magnet by rack or barrel plating using a first plating solution having a pH of between 3.0 and 6.0 and containing ZnCl being present between 20 g/L and 120 g/L, KCl being present between 120 g/L and 320 g/L, H₃BO₃ being present between 10 g/L and 100 g/L, and HT-MB zinc acid additive and zinc acid brightener being present between 0.1 g/L and 50 g/L.

14. The method as set forth in claim 11 wherein said step of depositing the second plating layer is defined electroplating the second plating layer containing Zinc-Nickel alloy onto the polished Nd—Fe—B magnet by rack or barrel plating using a second plating solution containing Zn²⁺ ions being present between 2 g/L and 20 g/L, Ni²⁺ ions being present between 1 g/L and 10 g/L, a metal complexing agent being present between 50 g/L and 200 g/L, and NaOH being present between 20 g/L and 200 g/L.

15. The method as set forth in claim 11 wherein said step of depositing the third plating layer is defined as electroplating the third plating layer containing Copper onto the washed Nd—Fe—B magnet by rack or barrel plating using a third plating solution having a pH of between 7 and 10 and containing Copper Pyrophosphate being present between 20 g/L and 120 g/L, Potassium Pyrophosphate being present between 100 g/L and 300 g/L, and a Copper Pyrophosphate agent and a Copper Pyrophosphate brightener being present between 0.1 g/L and 50 g/L.

16. The method as set forth in claim 11 wherein said step of depositing the fourth plating layer is defined as electroplating the fourth plating layer containing Nickel onto the Nd—Fe—B magnet including the third plating layer by rack or barrel plating using a fourth plating solution having a pH of between 3 and 5 and containing NiSO₄ being present between 150 g/L and 350 g/L, NiCl₂ being present between 10 g/L and 100 g/L, H₃BO₃ being present between 10 g/L and 100 g/L, and an Ni-88 Brightener and an A-5 softener being present between 0.1 g/L and 50 g/L.

17. The method as set forth in claim 11 wherein said step of depositing the first plating layer further including steps of:
polishing the Nd—Fe—B magnet including the first plating layer to produce a polished Nd-Fe-b magnet;
said step of polishing being further defined as polishing the Nd—Fe-b magnet using a polishing solution containing nitric acid being present between 0.1 vol. % and 3 vol. % to produce then polished Nd—Fe—B Magnet; and
said step of polishing further including a step of rinsing the polished Nd—Fe—B magnet.

18. The method as set forth in claim 11 wherein said step of depositing the second plating layer further includes a step of washing the Nd—Fe—B magnet including the second plating layer using water to produce a washed Nd—Fe—B magnet.

19. The method as set forth in claim 11 wherein said step of activating the cleaned Nd—Fe—B magnet is define as corroding the cleaned Nd—Fe—B magnet with an acidic solution present between 0.1 wt. % and 2 wt. %.

20. The method as set forth in claim 11 wherein said step of depositing the third plating layer further includes steps of:
activating the Nd—Fe—B magnet including the third plating layer;
said step of activating the Nd—Fe—B magnet including a step of corroding the Nd—Fe—B magnet including the third plating layer using a solution containing hydrochloric acid having a concentration of between 1 vol. % an d 5 vol. %; and
said step of activating the Nd—Fe—B magnet further including a step of washing the Nd—Fe—B magnet the third plating layer using water after said step of corroding;

21. The method as set forth in claim 11 further including a step of shaping the Nd—Fe—B magnet body prior to said step of cleaning the Nd—Fe—B magnet body; and
said step of shaping the Nd—Fe—B magnet being further defined as grinding and chamfering the Nd—Fe—B magnet in a centrifugal or vibratory polishing machine for 1 to 10 hours.
